(19) United States
(12) Patent Application Publication
(10) Pub. No.: US 2010/0043440 A1
(43) Pub. Date: Feb. 25, 2010

(54) Gas Turbine Burner and Method of Operating a Gas Turbine Burner

(76) Inventors: Andreas Heilos, Mulheim an der Ruhr (DE); Werner Krebs, Mulheim an der Ruhr (DE); Jaap Van Kampen, Roermond (NL)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/224,482

(22) PCT Filed: Feb. 20, 2007
(86) PCT No.: PCT/EP2007/051597

§ 371 Date: Nov. 5, 2009

(30) Foreign Application Priority Data
Feb. 28, 2006 (DE) 10 2006 009 562.6

(51) Int. Cl. F02C 7/22

(52) U.S. Cl. 60/737

(57) ABSTRACT

The invention is based on a gas turbine burner comprising a combustion zone for burning a mixture consisting of combustion exhaust gas to which fuel gas is added, and comprising a fuel intermixing arrangement having a fuel nozzle for spraying the fuel gas into the combustion exhaust gas. In order to achieve low-pollutant and uniform combustion, it is proposed that the fuel intermixing arrangement be designed for spraying the fuel gas into the combustion exhaust gas at at least 0.2 times the speed of sound.

### CROSS REFERENCE TO RELATED APPLICATIONS

This application is the US National Stage of International Application No. PCT/EP2007/051597, filed Feb. 20, 2007 and claims the benefit thereof. The International Application claims the benefits of German application No. 10 2006 009 562.6 filed Feb. 28, 2006, both of the applications are incorporated by reference herein in their entirety.

### FIELD OF INVENTION

The invention is based on a gas turbine burner comprising a combustion zone for burning a mixture consisting of combustion exhaust gas to which fuel gas is added, and comprising a fuel intermixing arrangement having a fuel nozzle for spraying the fuel gas into the combustion exhaust gas, the fuel intermixing arrangement being designed to spray the fuel (8) into the combustion exhaust gas at at least 0.2 times the speed of sound. Moreover, the invention is based on a method for operating a gas turbine burner comprising a combustion zone in which a mixture, consisting of combustion exhaust gas to which fuel gas is added, is burnt, the fuel gas being sprayed by a fuel nozzle into the combustion exhaust gas, and the fuel gas being sprayed into the combustion exhaust gas at at least 0.2 times the speed of sound.

### BACKGROUND OF THE INVENTION

For achieving steady and stable combustion in a gas turbine, it is known to spray fuel gas into hot combustion exhaust gases, so that a gas mixture is formed at a temperature above an auto-ignition temperature.

A combustion system for a gas turbine burner comprising a secondary combustion zone and a method for operating a gas turbine burner comprising a secondary combustion zone is disclosed in U.S. Pat. No. 5,617,718 A. In the secondary combustion zone, a mixture, consisting of combustion exhaust gas to which fuel gas is added from a primary combustion zone of a gas turbine, is burnt.

A fuel intermixing arrangement comprising a fuel nozzle for spraying the fuel gas into the combustion exhaust gas of a secondary combustion zone is disclosed in US 2005/0229581. The combustion exhaust gas is introduced into the secondary combustion zone by an acoustic screen, in order to damp acoustic pulsations in a mixing tube, in which the combustion nozzle is arranged, and in the combustion chamber.

A gas turbine, in which exhaust gas provided with fuel is sprayed into an afterburner zone at high speed, is disclosed in U.S. Pat. No. 4,896,501. It is known from U.S. Pat. No. 6,112,512 to spray in a pulsed manner exhaust gas mixed with fuel into an afterburner zone, in order to achieve a high penetration depth of the sprayed jet in the exhaust gas jet.

### SUMMARY OF INVENTION

The object of the invention is, in particular, to provide a gas turbine burner and a method for operating a gas turbine burner in which low pollutant combustion may be ensured.

The object relating to the gas turbine burner is achieved by a gas turbine burner of the type mentioned in the introduction, in which a spray jet consisting of fuel gas comprises at least one inner jet consisting of fuel-containing gas and an outer jet surrounding the inner jet consisting of cooling gas, the cooling gas being at a lower temperature than the combustion exhaust gas. As a result of the speed, which corresponds at least to mach number Ma=0.2, a hardness of the jet may be achieved, by means of which a high shear gradient—i.e. sharply decreasing speed over the edge region from the jet interior to the jet exterior—is achieved in the edge region of the jet. The shear gradient may, for example, be quantified by diverting the speed components of the fluid and/or gas in the longitudinal direction of the jet toward the transverse and/or radial direction relative to the center axis of the jet. A combustion reaction is not able to take place in areas with a high shear gradient, so that the mixture only ignites later compared to jets with a softer edge. As a result of this effect, the combustion is delayed and correct mixing of the combustion exhaust gases with the fuel gas may be ensured.

In conventional reheat combustion systems, the fuel already ignites after 0.3 ms or less, so that the fuel has little opportunity to mix with the combustion exhaust gas. As a result, a disadvantageous diffusion flame results, which leads to unacceptable NOx emissions. When a flame burns without premixing, it is known as a diffusion flame. The oxygen required for combustion as well as all other air components are diffused via the flame edge into the flame which is why, toward the flame core, oxygen is supplied increasingly inefficiently to the flame and, therefore, the fuel burns more slowly.

In contrast thereto, by means of the reheat combustion system according to the invention, instead of a visible flame front, non-luminous combustion, which is also known as mild combustion, colorless combustion or volume combustion, is possible and, in particular, is low polluting. The gas is mixed with the exhaust gas for auto-ignition in the regions with a shear gradient which is higher than a critical shear gradient, and only ignites when it is transported by means of convection into a region in which the value of the shear gradient is below the critical value. A large-volume flame zone is achieved in which the combustion is approximately uniform. By a suitable choice of the composition of the fuel gas, moreover, a very lean combustion may be achieved, which results in a low level of polluting components, such as NOx or CO in the secondary combustion exhaust gas.

An important parameter of the solution according to the invention is the speed of the jet relative to the reference system. The reference system may be the stationary combustion chamber, in particular when the combustion exhaust gas, which is sprayed into, flows slowly, so that the speed thereof may be disregarded. If the hot gas, which is sprayed into, moves rapidly, the reference system moving with the combustion exhaust gas surrounding the jet may thus be selected as a reference system. Then the speed at which the fuel gas is sprayed into the combustion exhaust gas is advantageously compared to the reference system moved by the combustion exhaust gas. The speed of sound is in this case expediently regarded as the speed of sound of the non-combusted fuel mixture containing fuel which emerges from the nozzle—hereinafter also simply known as fuel gas—which is dependent on the temperature and the pressure of the fuel gas. The fuel gas may thus be sprayed into the combustion exhaust gas by means of a jet at a speed which is at least as great as 0.2 times the speed of sound in the fuel gas.

Insofar as dispersive effects require a frequency dependency of the speed of sound, the value thereof may be used at several hundred hertz. The spraying speed may, for example, be measured in the center of the jet or averaged over the entire jet cross section or a part of the jet cross section.

The gas turbine burner is expediently an afterburner system and/or reheat combustion system or part of such a system. The fuel gas expediently contains a proportion of fuel which is sufficient to enrich the combustion exhaust gas with fuel at a predetermined temperature such that it ignites automatically. All fuels which may be used in gas turbines, for example heating oil, synthesis gas, natural gas, methanol or pure hydrogen as well as gas mixtures, may be used as fuel. The principle of delaying combustion by a high shear gradient which may be achieved by the high spraying speed is characterized by being substantially independent of the fuel used.

In an advantageous embodiment of the invention, the gas turbine burner comprises a primary combustion chamber, the combustion zone being arranged in an exhaust gas flow downstream of the primary combustion chamber and the fuel intermixing arrangement being provided for spraying the fuel gas into the combustion exhaust gas from the primary combustion chamber. The fuel gas may be sprayed into the combustion exhaust gas without it being necessary to recirculate the combustion exhaust gas, whereby a stable spray jet may be achieved with a high shear gradient.

In a development of the invention it is proposed that the fuel intermixing arrangement is designed to spray the fuel gas (4) into the combustion exhaust gas (6) at at least 0.4 times the speed of sound. Generally, the region in which the value of the shear gradient is above the critical value is all the larger, the more rapid and more powerful the jet. By spraying at a mach number of 0.4 which in technical terms may be implemented easily and cost-effectively, a marked delay in auto-ignition may already be achieved, which results in a satisfactory reduction in the concentration of pollutants in the secondary combustion exhaust gas.

When the fuel intermixing arrangement is designed to spray the fuel gas into the combustion exhaust gas at a speed which is lower than 0.9 times the speed of sound, a sufficient balance may be achieved between the requirements for greater speed, on the one hand, and for cost-effective fuel intermixing arrangements, on the other hand.

If the fuel intermixing arrangement comprises a premix unit for premixing the fuel gas with oxygen-containing gas, a lean, gentle combustion may be achieved with a low concentration of pollutants in the combustion products. The mixed product from the premixing is the fuel gas which is sprayed into the exhaust gas.

In particular, it is proposed that the premix unit is designed to premix the fuel gas with the oxygen-containing gas such that the ratio of the number of fuel molecules to the number of oxygen molecules is between 0.2 and 10. The lean combustion may already be achieved at jet speeds in the lower part of the speed range according to the invention, when the premix unit is designed to premix the fuel gas with the oxygen-containing gas such that the ratio of the number of fuel molecules to the number of oxygen molecules is less than 1.0.

Alternatively or additionally, inert material may be added to the fuel, the ratios provided above also expediently being taken into account, but with inert material instead of the oxygen-containing gas. In particular, water vapor, CO₂ or nitrogen is suitable as inert material. The proportion of particles of inert material may be up to ten times that of fuel. The fuel may also be sprayed as fuel gas without adding oxygen-containing gas or inert material.

Delaying the auto-ignition may be ensured when a shear gradient in an edge region of the jet, in a region in front of the nozzle outlet—i.e. downstream of the nozzle outlet—is above a critical shear gradient for auto-ignition.

In this case, it is advantageous when the length of the region in front of the nozzle outlet in which the shear gradient is above the critical shear gradient for auto-ignition, is at least 10 cm long. The length of the region naturally depends on the speeds of the jet and the combustion exhaust gas and is particularly advantageously selected so that auto-ignition is delayed by at least 1 ms.

When the fuel intermixing arrangement is designed to spray the fuel gas into the combustion exhaust gas at a pressure which is at least 20%, in particular at least 50%, higher than an average pressure in the secondary combustion zone, the jet may be produced in a particularly simple manner. Generally the ratio of the pressure difference between the jet pressure and the pressure of the combustion exhaust gas to the pressure of the combustion exhaust gas is the same as the ratio of the speed of the jet to the speed of sound in the combustion exhaust gas.

When the spray jet consisting of fuel gas comprises at least one inner jet consisting of fuel-containing gas and an outer jet surrounding the inner jet consisting of cooling gas, the cooling gas being at a lower temperature than the combustion exhaust gas, a particularly effective premixing may be achieved, as the auto-ignition is further delayed by the cooling gas, because reaching the auto-ignition temperature is delayed. Moreover, it should be noted that the critical value of the shear gradient is temperature-dependent, so that it is lowered by adding cooling gas. This may finally lead to an enlargement of the premix zone, in which the shear gradient is above the critical value which is dependent on the local temperature.

Effective cooling may be achieved when the temperature of the cooling gas is between 200° C. and 400° C.

If the speed of the outer jet consisting of cooling gas is the same as the speed of the inner jet, the hardness of the jet edge is not reduced by the additional outer jet, so that a high shear gradient may be achieved.

The advantage of the delay in combustion may be further increased when the speed of the outer jet consisting of cooling gas is greater than the speed of the inner jet. A higher shear gradient may be achieved between the outer jet and the surroundings than is possible only between the inner jet and the surroundings, whereby the combustion may be further delayed.

When, on the other hand, the speed of the outer jet consisting of cooling gas is lower than the speed of the inner jet, the outer jet may be produced in a cost-effective manner without costly compressors and nozzles. When the cooling gas contains fuel, a uniform fuel concentration may be achieved in the flame zone.

A cost-effective implementation of the gas turbine burner may be achieved by the cooling gas consisting at least substantially of air.

The advantages of the invention are noticeable due to the particularly rapid auto-ignition in this temperature range, in particular when the temperature of the combustion exhaust gas is between 900° C. and 1600° C.

The object relating to the method is achieved by a method for operating a gas turbine of the type mentioned in the introduction, in which according to the invention a spray jet consisting of fuel gas comprises at least one inner jet consisting of fuel-containing gas and an outer jet surrounding the inner jet consisting of cooling gas, the cooling gas being at a lower temperature than the combustion exhaust gas.

### BRIEF DESCRIPTION OF THE DRAWINGS

The invention is explained in more detail with reference to exemplary embodiments which are shown in the drawings, in which:

FIG. 1 shows a gas turbine burner with a secondary combustion zone according to a first exemplary embodiment of the invention,

FIG. 2 shows a fuel nozzle of a reheat combustion system according to an alternative embodiment of the invention and

FIG. 3 shows a fuel nozzle designed as a lance of a reheat combustion system according to a further alternative embodiment of the invention.

### DETAILED DESCRIPTION OF INVENTION

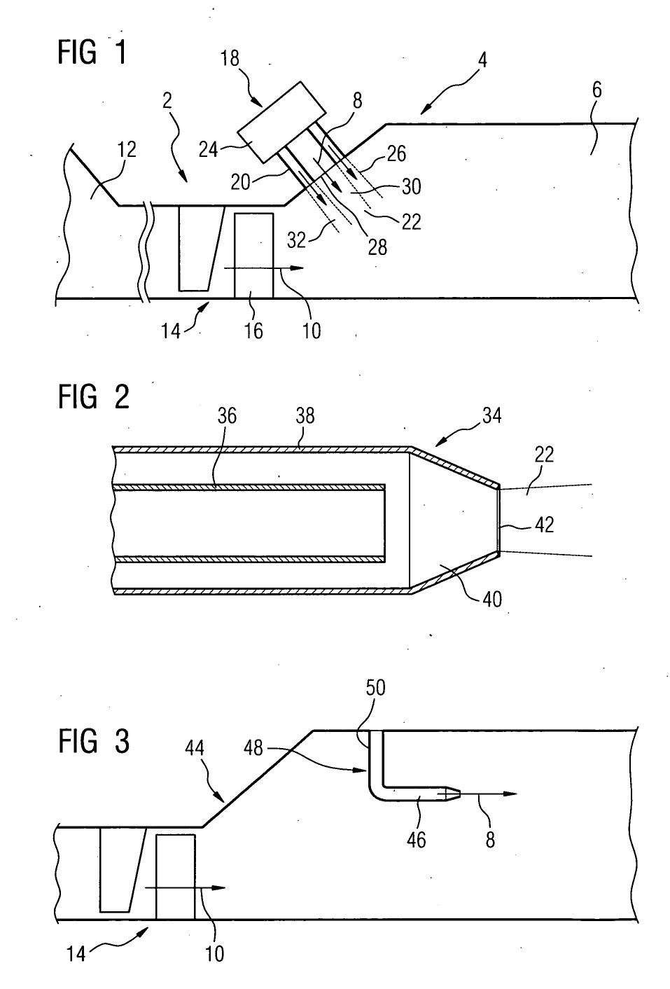

FIG. 1 shows a reheat combustion system 2 for a gas turbine installation comprising a gas turbine burner 4 with a secondary combustion zone 6 in which a mixture of combustion exhaust gas 10 to which fuel gas 8 is added is burnt. The combustion exhaust gas 10 issues from a primary combustion chamber 12 of the gas turbine installation; upstream of the combustion zone 6 relative to the combustion exhaust gas 10, which is separated from the combustion zone 6 by a turbine stage 14 of the gas turbine, the rotor blades 16 thereof being driven by the combustion exhaust gases 10 from the combustion chamber 12. The secondary combustion zone 2 is substantially annular and rotationally symmetrical to a rotational axis, not shown, of the turbine stage 14. The combustion exhaust gas 10 flowing into the secondary combustion zone 6 is at a temperature which is between 900° C. and 1600° C. Instead of the separation of the secondary combustion zone 2 from the primary combustion chamber 12 by the turbine stage 14, a preliminary combustion stage is possible upstream of the secondary combustion zone 2 in a common combustion chamber, instead of the primary combustion chamber 12.

The reheat combustion system 2 comprises a fuel intermixing arrangement 18 comprising a fuel nozzle 20 through which the fuel gas 8 is introduced into the combustion exhaust gas 10, flowing axially into the secondary combustion zone 2, relative to the rotational axis of the turbine stage 14, with a direction component oriented radially inwardly.

The fuel intermixing arrangement 18 is designed, as a result of powerful compressors and the nozzle geometry, to spray fuel gas 8 in the high impulse and rapid spray jet 22 into the combustion exhaust gas 10. Depending on sensor signals which contain parameters for a state of the reheat combustion system 2, the speed of the nozzle jet 22 may be flexibly adapted to the detected state, by a control unit not shown here of the reheat combustion system 2 adjusting a compressor pressure of the fuel intermixing arrangement 18.

The speed, however, in the combustion exhaust gas 10, at least in an operating mode in which combustion is carried out at a high shear gradient, is in the range of between 0.4 times and 0.9 times the speed of sound. The control unit may additionally determine the speed depending on the pressure and the temperature of the combustion exhaust gas 10 or control a fixed speed of the nozzle jet__{—}2_wHiAh_exceeds the minimum speed corresponding to 0.4 times the speed of sound, in any case at all temperatures and pressures which occur.

In an operating mode characterized by particularly low polluting combustion, the fuel intermixing arrangement 8 sprays the fuel gas 4 into the combustion exhaust gas 6 at a speed which is between 0.6 times and 0.8 times the speed of sound in the combustion exhaust gas 10.

In this exemplary embodiment, the fuel nozzle 20 is designed as a subsonic nozzle so that the fuel intermixing arrangement 18 is able to spray the fuel gas 8 into the combustion exhaust gas 10 at most at a speed which corresponds to 0.9 times the speed of sound in the combustion exhaust gas 10.

The fuel intermixing arrangement 18 further comprises a premix unit 24, only shown schematically here, for premixing the fuel gas 8 with oxygen-containing gas or an inert material. The premix unit 24 is able to premix the fuel gas 8 with the corresponding gas in a variably adjustable mixing ratio. The range of possible mixing ratios, i.e. the possible ratios of the number of fuel molecules to the number of oxygen molecules ranges, in particular, between 0.2 and 2.0.

At least in combustion mode, at a high shear gradient, the control unit operates the premix unit 24 such that said premix unit premixes the fuel gas 8 with the oxygen-containing gas at such a ratio that the ratio of the number of fuel molecules to the number of oxygen molecules is less than 1.0.

The speed of the spray jet 22 is sufficiently high for a shear gradient in an edge region 26 of the high impulse jet 12 to be above a critical shear gradient for auto-ignition in a region in front of a nozzle outlet 28. In this case, the length of the region in front of the nozzle outlet 28 in which the shear gradient is above the critical shear gradient for auto-ignition, is at least 10 cm.

To produce the high speeds, the fuel intermixing arrangement 18 comprises a compressor, not shown here, so that it may spray the fuel gas 8 into the combustion exhaust gas 10 at a pressure which is at least 20% higher than an average pressure of the combustion exhaust gas 10 in the secondary combustion zone 6. In the exemplary embodiment shown, the pressure of the combustion exhaust gas 6 from the primary combustion zone into the secondary combustion zone 2 is approximately 20 bar, and the pressure of the fuel gas 4 is 30 bar.

In this case, the nozzle jet 22 consists of fuel gas 8 consisting of an inner jet 30 consisting of fuel-containing gas and an outer jet 32 consisting of cooling gas surrounding the inner jet 30. The temperature of the cooling gas is between 200° C. and 600° C., so that the cooling gas is at a lower temperature than the combustion exhaust gas 10 which flows from the primary combustion zone into the secondary combustion zone 6.

During operation of the reheat combustion system, fuel gas is burnt in the primary combustion chamber 12 and the hot combustion exhaust gases 10 flow through the turbine stage 14 into the secondary combustion zone 6. In this exhaust gas flow the fuel gas 8 is sprayed in a jet 12 into the combustion exhaust gas 10 at a speed which is at least as great as 0.2 times the speed of sound in the combustion exhaust gas 10. In a first exemplary embodiment, therefore, the speed of the outer jet 32 consisting of cooling gas is the same as the speed of the inner jet 30, so that between the inner jet 30 and the outer jet 32 no shear gradient is produced. The high shear gradient is thus produced in the edge region 26, at the transition between the outer edge of the outer jet 32 and the combustion exhaust gas 10 surrounding the entire spray jet 22.

In an alternative embodiment, which is structurally less complicated, the speed of the outer jet 32 consisting of cooling gas is lower than the speed of the inner jet 30.

The cooling gas consists at least substantially of inert material such as nitrogen, CO₂ or water vapor, the fuel intermixing arrangement 18 being able to add fuel to the cooling gas in an adjustable ratio, in order to homogenize the flame. Alternatively, it is also conceivable to provide air in the cooling gas or as cooling gas.

FIG. 2 shows a fuel nozzle 34 of an alternative reheat combustion system. The fuel nozzle 34 comprises an inner tube 36 and an outer tube 38 concentrically surrounding the inner tube 36 which projects beyond the inner tube 36 to the front in the flow direction and which in a front mixing region 40 has a conically tapering cross section which terminates at a round outlet aperture 42 of the fuel nozzle 34.

Pure fuel or at least a gas with a high fuel content is conducted in the inner tube 36, whilst an oxygen-rich bypass flow is conducted in the space between the inner tube 36 and the outer tube 38 and which conducts air in a preferred embodiment. In the mixing region 40, the gas with a high fuel content and the oxygen-containing bypass flow are mixed to form the premixed fuel gas 8.

The fuel gas 8 is accelerated in the conically tapering front mixing region 40 of the fuel nozzle 34, as the speed averaged over the jet profile is substantially inversely proportional to the cross-sectional area. The premixed fuel gas 8 is finally introduced through the outlet opening 42 in a spray jet 22 into the secondary combustion zone 6.

FIG. 3 shows an alternative reheat combustion system 44 which differs from the reheat combustion systems shown in FIGS. 1 and 2, in particular by a fuel nozzle 48 embodied as a lance 46 and projecting into the center of the flow of combustion exhaust gas 10. The fuel gas 8 is supplied by a tube 50 projecting radially relative to the rotational axis of the turbine stage 14 into the secondary combustion zone 6 of the fuel nozzle 48. The lance 46 facing in the flow direction of the combustion exhaust gas 10 supplied in the secondary combustion zone 6 is attached to the radial internal end of the tube 50, and through said lance the fuel gas 8 is sprayed into the combustion exhaust gas 10 in a spray jet 22 at a mach number which is in a preferred range between 0.4 and 0.9, substantially in the flow direction of the combustion exhaust gas 10.

1.-18. (canceled)

19. A gas turbine burner comprising:
a combustion zone for burning a mixture consisting of combustion exhaust gas to which a fuel gas is added; and
a fuel intermixing arrangement having a fuel nozzle that sprays the fuel gas into the combustion exhaust gas at at least 0.2 times the speed of sound, wherein the spray jet consists of fuel gas comprises
at least one inner jet consisting of fuel-containing gas, and
an outer jet surrounding the inner jet consisting of cooling gas, the cooling gas being at a lower temperature than the combustion exhaust gas.

20. The gas turbine burner as claimed in claim 19,
wherein a primary combustion chamber that provides the combustion exhaust gas is provided up stream of the combustion zone,
wherein the combustion zone is arranged in the exhaust gas flow downstream of the primary combustion chamber, and
wherein the fuel intermixing arrangement sprays the fuel gas into the combustion exhaust gas from the primary combustion chamber.

21. The gas turbine burner as claimed in claim 20, wherein the fuel intermixing arrangement sprays the fuel gas into the combustion exhaust gas at at least 0.4 times the speed of sound.

22. The gas turbine burner as claimed in claim 21, wherein the fuel intermixing arrangement sprays the fuel gas into the combustion exhaust gas at a speed between 0.4 and 0.9 times the speed of sound in the fuel gas.

23. The gas turbine burner as claimed in claim 22, wherein the fuel intermixing arrangement comprises a premix unit that premixes the fuel gas with an oxygen-containing gas or an inert material.

24. The gas turbine burner as claimed in claim 23, wherein the premix unit premixes the fuel gas with the oxygen-containing gas such that the ratio of the number of fuel molecules to the number of oxygen molecules is less than 10.

25. The gas turbine burner as claimed in claim 23, wherein the premix unit is premixes the fuel gas with the oxygen-containing gas such that the ratio of the number of fuel molecules to the number of oxygen molecules is between 0.2 and 1.0.

26. The gas turbine burner as claimed in claim 25, wherein a shear gradient in an edge region at least one of the spray jets in a region in front of a nozzle outlet is above a critical shear gradient for auto-ignition of the fuel gas.

27. The gas turbine burner as claimed in claim 26, wherein the fuel intermixing arrangement sprays fuel gas into the combustion exhaust gas at a pressure at least 20% higher than an average pressure in the combustion zone.

28. The gas turbine burner as claimed in claim 27, wherein the fuel intermixing arrangement sprays fuel gas into the combustion exhaust gas at a pressure at least 50% higher than an average pressure in the combustion zone.

29. The gas turbine burner as claimed in claim 28, wherein the temperature of the cooling gas is between 200° C. and 600° C.

30. The gas turbine burner as claimed in claim 29, wherein the speed of the outer cooling gas jet is the same as the speed of the inner jet.

31. The gas turbine burner as claimed in claim 29, wherein the speed of the outer cooling gas jet is greater than the speed of the inner jet.

32. The gas turbine burner as claimed in claim 29, wherein the cooling gas contains fuel.

33. The gas turbine burner as claimed in claim 32, wherein the cooling gas substantially consists of inert material and/or air.

34. The gas turbine burner as claimed in claim 33, wherein the temperature of the combustion exhaust gas in the combustion zone is between 900° C. and 1600° C.

35. A method for operating a gas turbine burner comprising:
providing a hot combustion gas;
arranging a combustion zone such that the hot combustion gas is received by the combustion zone;
mixing a fuel gas with the hot combustion gas within a combustion zone wherein the fuel gas is sprayed into the combustion exhaust gas at at least 0.2 times the speed of sound, wherein the fuel gas spray jet comprises:
at least one inner jet consisting of a fuel-containing gas and
an outer jet surrounding the inner jet consisting of a cooling gas that is at a lower temperature than the combustion exhaust gas; and
burning the fuel gas within the combustion zone.

36. The method as claimed in claim 35,
wherein the primary combustion chamber that provides the combustion exhaust gas is provided up stream of the combustion zone,
wherein the combustion zone is arranged in the exhaust gas flow downstream of the primary combustion chamber, and
wherein the fuel is sprayed into the combustion exhaust gas from the primary combustion chamber.

37. The method as claimed in claim 36, wherein the fuel intermixing arrangement sprays the fuel gas into the combustion exhaust gas at a speed between 0.4 and 0.9 times the speed of sound in the fuel gas.

38. The method as claimed in claim 37, wherein the fuel gas is premixed with an oxygen-containing gas or an inert material.
